(19) United States
(12) Patent Application Publication
(10) Pub. No.: US 2022/0228631 A1
(43) Pub. Date: Jul. 21, 2022

(54) Vibration damping TBM TORQUE LIMITING CLUTCH

(71) Applicant: Dong SHI, Nanjing (CN)

(72) Inventor: Dong SHI, Nanjing (CN)

(21) Appl. No.: 17/593,546

(22) PCT Filed: Oct. 12, 2019
(86) PCT No.: PCT/CN2019/110794

§ 371 Date: Sep. 20, 2021

(51) Int. Cl. F16D 43/206; B25B 23/14

(52) U.S. Cl. CPC F16D 43/206; B25D 2250/165; B25B 23/141

(57) ABSTRACT

The present disclosure discloses a vibration damping TBM torque limiting clutch, including a driving end and a driven end which are axially sleeved. A fixed torque fastener is arranged between the driving end and the driven end; an inner spline hole of the driving end is axially sleeved to a motor hollow spline shaft; the tail part of the driven end is axially connected with a high-vibration damping rubber ring; and the rubber ring is wrapped outside of an inner spline hub; the rubber ring and the inner spline hub are fixed by a fastener; a reducer spline shaft is inserted into the inner spline hub after penetrating through the motor hollow spline shaft, and then is connected to the spline of the inner spline hub. The design mainly reduces the overload disengaged rate to an extremely large extent by means of shielding instantaneous torque pulses, and well resolve the defects in the existing technology.

### TECHNICAL FIELD

The present disclosure belongs to the design from TBM (Tunnel Boring Machine) field, in particular, a torque limiting clutch capable of power transmission engagement or disengagement.

### BACKGROUND

At present, due to the diversity of strata and varied load types in the tunneling process of a known TBM, the torque fluctuates greatly. The power of electric-driven TBM is transmitted from motor to reducer, and an overload protection clutch is added between them. Once the torque exceeds the load of equipment, the clutch will be disengaged immediately, that is, the driving and driven ends are separated, which effectively avoids damage to parts such as the motor, reducer etc. In a torque transmission structure, if with a simply rigid structure, frequent torque pulse jumps will end up with the frequent disengagement of the clutch, which greatly affects the TBM efficiency.

FIG. 1 & FIG. 2 present the overload clutch schematic. Normally, the clutch is engaged while at the moment of overloading, the balls will slip out of the groove, with absolutely 0 residual torque, separated between the driving and driven sides. The clutch will not automatically reset, even after a long-term operation, it will still be empty-load operation, which perfectly suits for the high rotation speed applications.

The information disclosed in the background section intended to enhance the understanding of the overall background, and should not be regarded as an acknowledgement or any form of suggestion that the information constitutes the existing technology known to those of ordinary skill in the art.

### SUMMARY

The present disclosure aims to provide a vibration damping TBM torque limiting clutch, so as to overcome the defects in the existing technology.

In order to achieve the above purpose, the present disclosure provides a vibration damping TBM torque limiting clutch, including a driving end and a driven end which are axially sleeved. A fixed torque fastener is arranged between the driving end and the driven end;

an inner spline hole of the driving end is axially connected to a motor hollow spline shaft;

the tail part of the driven end axially fixed to a high-vibration damping rubber ring, which is wrapped outside an inner spline hub; the rubber ring and the inner spline hub are connected by fasteners;

a reducer spline shaft is inserted into the inner spline sleeve after penetrating into the motor hollow spline shaft, and is connected with its spline.

In the tunneling process of TBM, there are a variety of load types, particularly in a sandy soft rock stratum or other complicated rock stratums, and the load types are with the characteristic of pulse jump. Furthermore, in these torque pulses, most of pulse torques are large and short. With a purely rigid structure, such frequent torque pulse jumps will cause the overload clutch to be disengaged frequently. According to this design, a natural damping elastomer is additionally mounted in the traditional rigid torque transmission system. This elastomer has an extremely strong damping and vibration absorbing function, and is capable of filtering the torque pulses of the loads by means of its damping function, which will shield most transient pulse torques which cause frequent disengagement, and thereby greatly reducing the overload clutch disengagement rate.

Preferably, in the above technical solution, a radial ring body of the high-vibration damping rubber ring is inserted into the outer ring of the inner spline hub, and a dot-like fixed part is arranged between the radial ring and the outer ring; and an axial ring body of high-vibration damping rubber ring is abutted with the end of the clutch, and a dot-like fixed part is arranged between the axial ring body and the tail end. Since the shield machine has extremely high power, the TBM needs to be fixed during energy absorption to ensure no failures.

Preferably, in the above technical solution, the inner spline hole of the driving end is axially sleeved to the motor hollow spline shaft, and both of them are axially limited via a flange and outer hex-bolts.

Preferably, in the above technical solution, the reducer spline shaft is inserted into the inner spline hub through spline connection, and the spline shaft end of the reducer spline shaft is axially limited by a shaft end block and inner hex-bolts.

Preferably, in the above technical solution, the fixed torque fastener is elastic modules or elastic steel balls.

Preferably, in the above technical solution, the high-vibration damping rubber ring (4) technically needs to satisfy the following: hardness: 40 ShA to 60 ShA; allowable damping power (W) (at 60° C.): 80 to 160; and relative damping coefficient: 0.6 to 1.2.

Preferably, in the above technical solution, the high-vibration-damping rubber ring (4) is made of natural rubber (NR).

Compared with the existing technology, the present disclosure has the following beneficial effects:

the overload disengagement rate is significantly reduced by means of shielding instantaneous torque pulses, and the defects in the existing technology are well solved.

### BRIEF DESCRIPTION OF THE DRAWINGS

FIG. 1 is a schematic diagram when an ordinary clutch is in a normal state;

FIG. 2 is a schematic diagram when an ordinary clutch is in an overload state;

FIG. 3 is a schematic diagram of installation of the present disclosure on a shield machine; and

FIG. 4 is a statistical chart of overload disengagement rates before & after use of the present disclosure.

In the drawings: 1: flange; 2: mark line; 3: overload clutch; 4: high-vibration damping elastomer; 5: inner hex-bolts; 6: inner hex-bolts; 7: inner hex-bolts 8: shaft end block; and 9: internal spline hub.

### DESCRIPTION OF THE EMBODIMENTS

The specific implementation modes of the present disclosure are described in detail below, but it should be understood that the protection scope of the present disclosure is not limited by the specific implementation modes.

Unless otherwise expressly stated otherwise, throughout the specification and claims, the term “include” or its transformations such as “includes” or “including” will be understood to include the stated elements or components, and other elements or other components are not excluded.

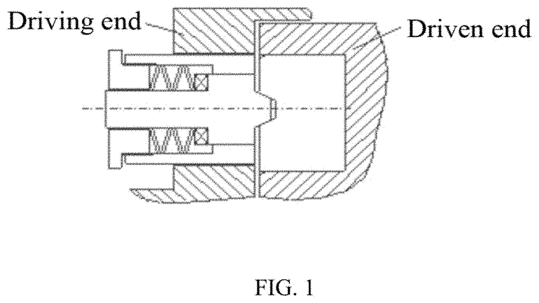

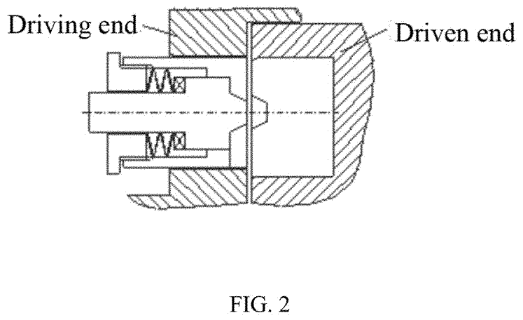

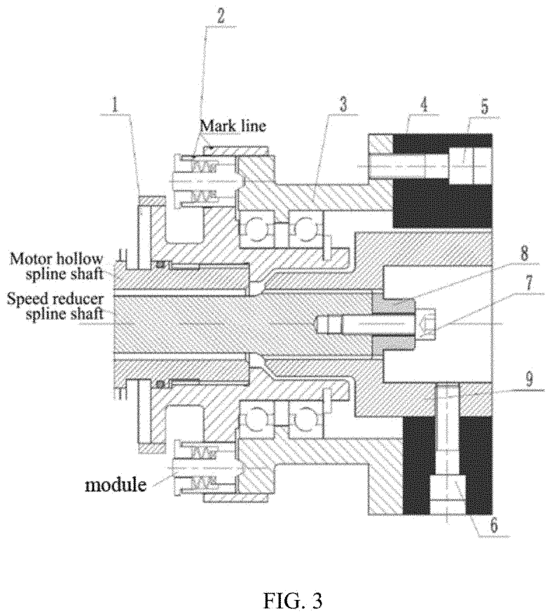

As shown in FIG. 3, the present disclosure mainly connects a motor shaft of a TBM and a reducer shaft by mounting 9 parts. A clutch includes a driving end and a driven end which are axially sleeved (it can be understood in combination with FIG. 1 or FIG. 2). A fixed torque fastener is arranged between the driving end and the driven end. The fixed torque fastener is elastic modules or elastic steel balls.

An internal spline hole of the driving end is axially sleeved to a motor hollow spline shaft, and they are axially limited by means of a flange 1 and an outer hexagon bolt 2.

The tail part of the driven end is axially fixedly connected with a high-vibration damping rubber ring 4. And the rubber ring 4 is wrapped outside the inner spline hub 9; and they are fixed by fasteners. A radial ring of the rubber ring 4 is sleeved with an outer ring of the inner spline hub 9, and a dot-like fixed part is arranged between the radial ring body and the outer ring; and axial ring of the rubber ring 4 is abutted with the tail end of the driven end of an overload clutch, and a dot-like fixed part is arranged between the axial ring and the tail end.

A reducer spline shaft is inserted into the inner spline hub 9 by spline connection after penetrating through the motor hollow spline shaft, and the end of the reducer spline shaft is axially limited by a shaft end block 8 and inner hex-bolts 7.

Simply, the inner spline hole of the overload clutch 3 and the motor shaft connected through a spline and are axially limited by the flange 1 and the outer hex-bolts 2; the high-vibration damping rubber ring 4 is connected with the inner spline hob 9 through the inner hex-bolts 6; this assembly is then disassembled into the overload clutch 3 and connected to the overload clutch 3 with the inner hex-bolts 6; the reducer spline shaft penetrates through the motor hollow spline shaft and is inserted into the inner spline hub 9 by spline connection; and the shaft end is axially limited by the block 8 and the inner hex-bolts 7.

In the vibration damping TBM overload clutch disclosed by the present disclosure, power is transmitted from the motor hollow spline shaft to the overload clutch 3, to the high-vibration damping elastomer 4, to the inner spline hub 9, to the reducer spline shaft consequently. For this overload clutch, several precise modules are equispaced around the clutch, so that at the moment of overloading, driving and driven transmissions can be completely disengaged (the residual torque is 0), and the reaction time is about 5 Ms. Each module pops out backwards. After the overload is eliminated, in a stop state, two mark-lines on the driving and driven ends are aligned; a plastic hammer or lever is used to apply an acting force to make the modules reset. The set-up disengaged value can also be steplessly adjusted within a certain range.

Partial parameters of the natural (NR) rubber elastomer:

Hardness: 40 ShA to 60 ShA,

Allowable damping power (W) (at 60° C.): 80 to 160,

Relative damping coefficient: 0.6 to 1.2.

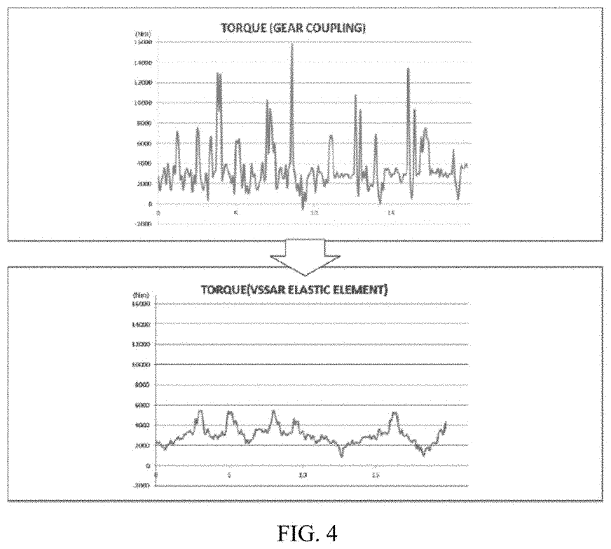

After use of the present disclosure, as shown in FIG. 4, the fluctuation range of a torque is reduced from about 0-16000 Nm to about 1000-5500 Nm, which is greatly reduced. It is also apparent that a fluctuation curve tends to be steady.

The foregoing description of specific exemplary implementation solutions of the present disclosure is for the purpose of explanation and illustration only. These descriptions are not intended to limit the present disclosure to the precise form disclosed. Furthermore, it is obvious that many changes and variations can be made based on the above illustrations. The purpose of selecting and describing exemplary embodiments is to explain the specific principles of the present disclosure and its practical application, so that those skilled in the art can implement and use various different exemplary implementation solutions of the present disclosure and various different selections and changes. The scope of the present disclosure is intended to be defined by the claims and their equivalents.

1. A vibrations damping tunnel boring machine (TBM) torque limiting clutch, composed of a driving end and driven end which are sleeved axially, wherein a fixed torque fastener is arranged between the driving end and driven end;
an inner spline hole of the driving end is axially sleeved to a motor hollow spline shaft;
the tail part of the driven end is axially fixedly connected with a high-vibration damping rubber ring (4); the rubber ring (4) is wrapped outside an inner spline hub (9); the rubber ring and the inner spline hub are fixedly connected through fasteners;
a reducer spline shaft is inserted into the inner spline hub (9) after penetrating through the motor hollow spline shaft, and is connected to a spline of the inner spline hub.

2. The vibration damping TBM torque limiting clutch according to claim 1, wherein a radial ring body of the high-vibration damping rubber ring (4) is sleeved with an outer ring of the inner spline hub (9), and a dot-like fixed part is arranged between the radial ring body and the outer ring; and an axial ring body of the rubber ring (4) is abutted with the tail end of the overload clutch (3), and a dot-like fixed part is arranged between the axial ring body and the tail end.

3. The vibration damping TBM torque limiting clutch according to claim 1, wherein the inner spline hole of the driving end is axially sleeved to the motor hollow spline shaft, and the inner spline hole and the motor hollow spline shaft are axially limited through a flange (1) and outer hex-bolts (2).

4. The vibration damping TBM torque limiting clutch according to claim 1, wherein the reducer spline shaft is inserted into the inner spline hub (9) by spline connection, and the shaft end of the reducer spline shaft is axially limited by a shaft end block (8) and an inner hex-bolts (7).

5. The vibration damping TBM torque limiting clutch according to claim 1, wherein the fixed torque fastener is an elastic module or an elastic steel ball.

6. The vibration damping TBM torque limiting clutch according to claim 1, wherein technical parameters of the high-vibration damping rubber ring (4) need to satisfy the following: hardness: 40 ShA to 60 ShA; allowable damping power (W) (at 60° C.): 80 to 160; and relative damping coefficient: 0.6 to 1.2.

7. The vibration damping TBM torque limiting clutch according to claim 6, wherein the high-vibration damping rubber ring (4) is natural (NR) rubber.

8. The vibration damping TBM torque limiting clutch according to claim 2, wherein technical parameters of the high-vibration damping rubber ring (4) need to satisfy the following: hardness: 40 ShA to 60 ShA; allowable damping power (W) (at 60 ° C.): 80 to 160; and relative damping coefficient: 0.6 to 1.2.

9. The vibration damping TBM torque limiting clutch according to claim 8, wherein the high-vibration damping rubber ring (4) is natural (NR) rubber.
